(19) United States
(12) Patent Application Publication
(10) Pub. No.: US 2024/0192385 A1
(43) Pub. Date: Jun. 13, 2024

(54) METHOD AND DEVICE FOR SUPPORTING POSITIONING INTEGRITY IN WIRELESS COMMUNICATION SYSTEM

(71) Applicant: Samsung Electronics Co., Ltd., Suwon-si, Gyeonggi-do (KR)

(72) Inventor: June HWANG, Suwon-si (KR)

(21) Appl. No.: 18/284,744

(22) PCT Filed: Apr. 1, 2022
(86) PCT No.: PCT/KR2022/004683

§ 371 Date: Sep. 28, 2023

(30) Foreign Application Priority Data
Apr. 1, 2021 (KR) 10-2021-0042816

(51) Int. Cl. G01S 19/42; G01S 19/05

(52) U.S. Cl. CPC G01S 19/42; G01S 19/05

(57) ABSTRACT

The disclosure relates to a fifth generation (5G) or sixth generation (6G) communication system for supporting higher data rates. A method performed by a user equipment (UE) in a wireless communication system is provided. The method may include: transmitting, to a location server, capability information of the UE related to global navigation satellite system (GNSS) positioning integrity (PI); receiving information about one or more key performance indicators (KPIs) from the location server; and transmitting, to the location server, resultant information about the GNSS PI, based on the one or more KPIs.

### CROSS-REFERENCE TO RELATED APPLICATION(S)

This application is a U.S. National Stage application under 35 U.S.C. § 371 of an International application number PCT/KR2022/004683, filed on Apr. 1, 2022, which is based on and claimed priority of a Korean patent application number 10-10-2021-0042816, filed on Apr. 1, 2021, in the Korean Intellectual Property Office, the disclosure of which is incorporated by reference herein in its entirety.

### TECHNICAL FIELD

The disclosure relates to a method and apparatus for transmitting positioning integrity information for a global navigation satellite system (GNSS) in a wireless communication system. Specifically, the disclosure relates to a signaling system required to reflect a positioning integrity result during a positioning operation of a user equipment (UE) using GNSS measurement.

### BACKGROUND ART

Fifth generation (5G) mobile communication technologies define wide frequency bands to allow for high transmission rates and new services, and may also be implemented not only in a sub-6 Gigahertz (GHz) band, e.g., 3.5 GHz, but also in an ultrahigh frequency band (above 6 GHZ) referred to as millimeter waves (mmWave) such as 28 GHz and 39 GHz. Moreover, for sixth generation (6G) mobile communication technologies referred to as a beyond 5G system, it is considered to be implemented in Terahertz (THz) bands (e.g., bands from 95 GHz to 3 THz) to attain transmission rates 50 times higher than an ultra-low delay reduced to one-tenth of the 5G mobile communication technology.

In an early stage of the 5G mobile communication technology, beamforming and massive multiple input multiple output (MIMO) to mitigate a radio path loss and increase the radio propagation distance in the ultra-high frequency band, support for various numerologies (operation of multiple subcarrier spacing) and dynamic slot format operation for efficient use of ultra-high frequency resources, initial access technologies for supporting multiple-beam transmission and widebands, definition and operation of bandwidth parts (BWPs), new channel coding schemes such as polar codes for highly reliable transmission of control information and low density parity check (LDPC) codes for high-volume data transmission, L2 preprocessing, network slicing for providing a dedicated network specialized for a particular service, etc., were standardized to support services and satisfy performance requirements for enhanced mobile broadband (eMBB), ultra-reliable low-latency communications (URLLC), and massive machine-type communications (mMTC).

Improvement and performance enhancement of the early 5G mobile communication technology are currently being discussed with consideration for the services that the 5G mobile communication technology has intended to support, and physical layer standardization for technologies such as vehicle-to-everything (V2X) to help driving decisions of autonomous vehicles and increase user convenience based on locations and status information of the vehicles transmitted by the vehicles, new radio unlicensed (NR-U) to aim at system operations conforming to various regulatory requirements in an unlicensed band, an NR terminal low-power consumption technology (UE power saving), non-terrestrial network (NTN), which is a direct terminal-satellite communication for securing coverage in a region where communication with a terrestrial network is unavailable, positioning, etc., is on going.

In addition, standardization of wireless interface architecture/protocol areas for technologies such as industrial Internet of things (IIoT) for supporting new services through connection and convergence with other industries, integrated access and backhaul (IAB) that provides a node to integrally support the wireless backhaul link and the access link to extend the network service area, mobility enhancement including conditional handover and dual active protocol stack (DAPS) handover, 2-step random access channel (RACH) for new radio (NR) to simplify the random access procedure, etc., and standardization of system architectures/service areas such as 5G baseline architectures (e.g., service based architectures or service based interfaces) for combination of network functions virtualization (NFV) and software-defined networking (SDN), mobile edge computing (MEC) to receive services based on a location of the terminal, etc., is also underway.

When such 5G mobile communication systems are commercialized, explosively increasing connected devices may be connected to the communication network, so that it is expected that enhancement of functions and performance of the 5G mobile communication system and integrated operation of the connected devices are required. For this, new research will be on the way for 5G performance enhancement and complexity reduction, artificial intelligence (AI) service support, metaverse service support, drone communication, etc., using AI, machine learning (ML) and extended reality (XR) to efficiently support augmented reality (AR), virtual reality (VR), mixed reality (MR), etc.

Advancement of the 5G mobile communication system may also be fundamental to developing not only a multiple antenna transmission technology such as large-scale antennas, array antennas, full dimensional multi-input multi-output (FD-MIMO) and new waveforms for guaranteeing coverage in THz bands of the 6G mobile communication technology, a high-dimensional spatial multiplexing technology using orbital angular momentum (OAM) and metamaterial based lens and antennas to enhance coverage of THz band signals, and a reconfigurable intelligent surface (RIS) technology, but also a full-duplex technology for frequency efficiency improvement and system network enhancement of the 6G mobile communication technology, an AI based communication technology to materialize system optimization by using a satellite and AI from a design stage and internalizing an end-to-end AI support function, a next generation distributed computing technology to materialize sophisticated services beyond the limit of terminal computation capacity by using ultra-high performance communication and computing resources, etc.

### DISCLOSURE

### Technical Solution

The disclosure provides an apparatus and method for effectively providing a protection level (PL) value associated with positioning integrity in a wireless communication system.

### DESCRIPTION OF DRAWINGS

FIG. 1 illustrates a structure of a long-term evolution (LTE) system, according to an embodiment of the disclosure.

FIG. 2 illustrates a radio protocol architecture of an LTE system, according to an embodiment of the disclosure.

FIG. 3 illustrates a structure of a next generation mobile communication system, according to an embodiment of the disclosure.

FIG. 4 illustrates a radio protocol architecture of a next generation mobile communication system, according to an embodiment of the disclosure.

FIG. 5 is a block diagram illustrating an internal structure of a user equipment (UE), according to an embodiment of the disclosure.

FIG. 6 is a block diagram illustrating a configuration of a base station (BS), according to an embodiment of the disclosure.

FIG. 7 is a flowchart of a case that a positioning integrity calculating entity and a positioning decision entity are a UE and a location management function (LMF), respectively, in UE-based positioning.

FIG. 8 is a flowchart of a case that a positioning integrity calculating entity and a positioning decision entity are an LMF and a UE, respectively, in LMF-based positioning.

FIG. 9 is a block diagram of a UE, according to an embodiment of the disclosure.

FIG. 10 is a block diagram of a BS, according to an embodiment of the disclosure.

FIG. 11 is a block diagram illustrating a structure of a location server, according to an embodiment of the disclosure.

### MODE FOR INVENTION

Advantages and features of the disclosure, and methods for attaining them will be understood more clearly with reference to the following embodiments which will be described in detail below along with the accompanying drawings. The disclosure may, however, be embodied in many different forms and should not be construed as limited to the embodiments set forth herein; rather, these embodiments are provided so that this disclosure will be thorough and complete, and will fully convey the scope of the embodiments of the disclosure to those of ordinary skill in the art. Like numbers refer to like elements throughout the specification.

It will be understood that each block and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two blocks shown in succession may in fact be executed substantially concurrently or the blocks may sometimes be executed in the reverse order, depending upon the functionality involved.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a larger number of components and modules. Moreover, the components and modules may be implemented to execute one or more central processing units (CPUs) in a device or security multimedia card. In embodiments, the module may include one or more processors.

Descriptions of some well-known technologies that possibly obscure the disclosure will be omitted, if necessary. Embodiments of the disclosure will now be described with reference to accompanying drawings.

Herein, terms to identify access nodes, terms to refer to network entities, terms to refer to messages, terms to refer to interfaces among network entities, terms to refer to various types of identification information, etc., are examples for convenience of explanation. Accordingly, the disclosure is not limited to the terms as herein used, and may use different terms to refer to the items having the same meaning in a technological sense.

Some of the terms and names defined by the 3rd generation partnership project (3GPP) long term evolution (LTE) will be used hereinafter. The disclosure is not, however, limited to the terms and definitions, and may equally apply to any systems that conform to other standards. In the disclosure, for convenience of descriptions, eNode B (eNB) may be interchangeably used with gNode B (gNB). For example, a base station referred to as an eNB may also indicate a gNB. Furthermore, the term ‘terminal’ or ‘UE’ may refer not only to a cell phone, an NB-IoT device, and a sensor but also to another wireless communication device.

In the following description, a base station is an entity for performing resource allocation for a terminal, and may be at least one of a gNB, an eNB, a Node B, a base station (BS), a radio access unit, a base station controller, or a node on a network. The terminal may include a user equipment (UE), a mobile station (MS), a cellular phone, a smart phone, a computer, or a multimedia system capable of performing a communication function. However, it is not limited thereto.

Especially, the disclosure may be applied to the 3GPP new radio (NR) (which is the 5G mobile communication standard). The disclosure may be applied to intelligent services based on the 5G communication and IoT related technologies, e.g., smart homes, smart buildings, smart cities, smart cars, connected cars, health care, digital education, smart retail, and security and safety services. In the disclosure, for convenience of descriptions, eNB may be interchangeably used with gNB. For example, a base station referred to as an eNB may also indicate a gNB. Furthermore, the term ‘terminal’ or ‘user equipment (UE)’ may refer not only to a cell phone, an NB-IOT device, and a sensor but also to other wireless communication devices.

Wireless communication systems are evolving from early systems that provide voice-oriented services to broadband wireless communication systems that provide high data rate and high quality packet data services such as 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e communication standards.

As a representative example of such a broadband wireless communication system, an LTE system adopts orthogonal frequency division multiplexing (OFDM) for a downlink (DL) and single carrier frequency division multiple access (SC-FDMA) for an uplink (UL). The UL refers to a radio link for a UE or MS to send data or a control signal to an eNode B or BS, and the DL refers to a radio link for a BS to send data or a control signal to a UE or MS. Such a multiple access scheme allocates and operates time-frequency resources for carrying data or control information for respective users not to overlap each other, i.e., to maintain orthogonality, thereby differentiating each user's data or control information.

As a future communication system after the LTE, the 5G communication system needs to freely reflect various demands from users and service providers and thus support services that simultaneously meet the various demands. The services considered for the 5G communication system may include enhanced Mobile Broadband (eMBB), massive Machine Type Communication (mMTC), Ultra Reliability Low Latency Communication (URLL), etc.

In some embodiments, the eMBB is aimed at providing more enhanced data rates than the LTE, LTE-A or LTE-Pro may support. For example, in the 5G communication system, the eMBB is required to provide 20 Gbps peak data rate in DL and 10 Gbps peak data rate in UL in terms of a single BS. Furthermore, the 5G communication system may need to provide an increasing user perceived data rate while providing the peak data rate. To satisfy these requirements, enhancement of various technologies for transmission or reception including multiple-input multiple-output (MIMO) transmission technologies may be required in the 5G communication system. While the present LTE uses up to 20 MHz transmission bandwidth in the 2 GHz band for signal transmission, the 5G communication system may use frequency bandwidth wider than 20 MHz in the 3 to 6 GHz band or in the 6 GHz or higher band, thereby satisfying the data rate required by the 5G communication system.

At the same time, in the 5G communication system, mMTC is considered to support an application service such as an Internet of Things (IOT) application service. In order for the mMTC to provide the IoT efficiently, support for access from massive number of terminals in a cell, enhanced coverage of the terminal, extended battery time, reduction in terminal price, etc., may be required. Because the IoT is equipped in various sensors and devices to provide communication functions, it may be supposed to support a large number of UEs in a cell (e.g., 1,000,000 terminals/km²). Furthermore, a UE supporting the mMTC is more likely to be located in a shadow area, such as a basement of a building, which might not be covered by a cell due to the nature of the service, so the mMTC may require an even larger coverage than expected for other services provided by the 5G communication system. The UE supporting the mMTC needs to be a low-cost terminal, and may require quite a long battery life time such as 10 to 15 years because it is difficult to frequently change the battery in the UE.

Finally, the URLLC may be a mission-critical cellular based wireless communication service, which may be used for services used for remote control over robots or machinery, industrial automation, unmanned aerial vehicle, remote health care, emergency alert, etc. Accordingly, communication offered by the URLLC may require very low latency (ultra-low latency) and very high reliability. For example, URLLC services may need to satisfy sub-millisecond (less than 0.5 millisecond) air interface latency and simultaneously has a requirement for a packet error rate of 10-5 or. Hence, for the URLLC services, the 5G system needs to provide a smaller transmit time interval (TTI) than for other services, and simultaneously requires a design that allocates a wide range of resources for a frequency band to secure reliability of the communication link.

Those three services considered in the aforementioned 5G communication system, i.e., eMBB, URLLC, and mMTC, may be multiplexed and transmitted from a single system. In this case, to meet different requirements for the three services, different transmission or reception schemes and parameters may be used between the services. The mMTC, URLLC, and eMBB are an example of different types of services, and embodiments of the disclosure are not limited to the service types.

Although the following embodiments of the disclosure will now be focused on an LTE, LTE-A, LTE Pro or 5G (or NR, next generation mobile communication) system for example, they may be equally applied to other communication systems with similar technical backgrounds or channel types. Furthermore, embodiments of the disclosure will also be applied to different communication systems with some modifications to such an extent that they do not significantly deviate from the scope of the disclosure when judged by those of ordinary skill in the art.

Operating principles of embodiments of the disclosure will now be described with reference to accompanying drawings. Detailed description of related well-known functions or features, which might obscure the gist of the disclosure, will be omitted in describing the following embodiments of the disclosure. Further, the terms, as will be mentioned later, are defined by taking functionalities in the disclosure into account, but may vary depending on practices or intentions of users or operators. Accordingly, the terms should be defined based on descriptions throughout this specification.

In an embodiment of the disclosure, a method of reducing redundant repetitive transmission may be introduced to control frequent signals in a case that a positioning integrity calculating entity is to deliver a calculation result to a positioning integrity decision entity.

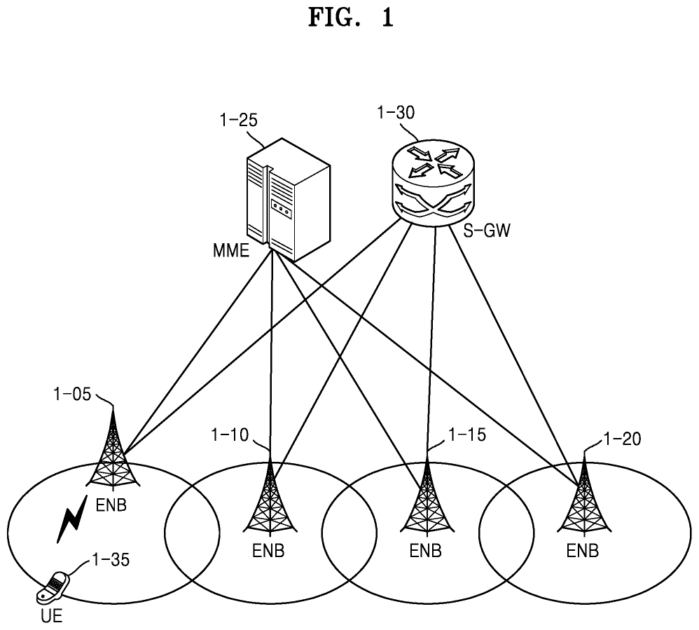

FIG. 1 illustrates a structure of an existing LTE system.

Referring to FIG. 1, a radio access network of the LTE system as shown may include evolved Node Bs (hereinafter, also referred to as ENBs, Node Bs, or base stations (BSs)) 1-05, 1-10, 1-15, and 1-20, a mobility management entity (MME) 1-25, and a serving gateway (S-GW) 1-30. A UE (or terminal) 1-35 may access an external network via the ENB 1-05 to 1-20 and the S-GW 1-30.

In FIG. 1, the ENBs 1-05 to 1-20 may correspond to the existing node Bs in a universal mobile telecommunication system (UMTS). The ENB may be connected to the UE 1-35 via a wireless channel, and may play a more sophisticated role than the existing node B does. In the LTE system, all user traffic including real-time services such as Voice over IP (VOIP) through the Internet protocol may be served on shared channels. Accordingly, there is a need for a device to aggregate status information about buffer status of UEs, available transmission power status, a channel condition, etc., and schedule them, and the ENBs 1-05 to 1-20 may serve as the device. A single ENB may generally control a number of cells. To achieve e.g., 100 Mbps of transmission speed, the LTE system may use orthogonal frequency division multiplexing (OFDM) as a radio access technology in e.g., 20 MHz bandwidth. Furthermore, an adaptive modulation and coding (AMC) scheme that determines a modulation scheme and channel coding rate according to a channel condition of the UE may be applied. The S-GW 1-30 may be a device to provide data bearers, producing or eliminating data bearers under the control of the MME 1-25. The MME is a device responsible for various control functions as well as a mobility management function for the UE, and may be connected to multiple BSs.

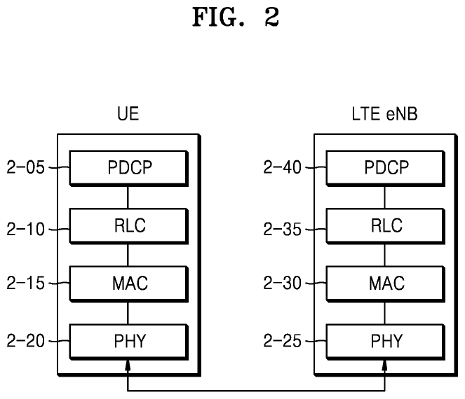

FIG. 2 illustrates a radio protocol architecture of an LTE system, according to an embodiment of the disclosure.

Referring to FIG. 2, the radio protocol of an LTE system may include, for each of the UE and the ENB, a packet data convergence protocol (PDCP) 2-05 or 2-40, a radio link control (RLC) 2-10 or 2-35 and a medium access control (MAC) 2-15 or 2-30. The PDCP may be responsible for operations such as IP header compression/reconstruction. The main functions of the PDCP may be summarized as follows:
header compression and decompression function (e.g., header compression and decompression: robust header compression (ROHC) only)
user data transfer function
sequential delivery function (e.g., in-sequence delivery of upper layer packet data units (PDUs) at PDCP re-establishment procedure for radio link control (RLC) acknowledged mode (AM))
reordering function (e.g., for split bearers in dual connectivity (DC) (only support for RLC AM): PDCP PDU routing for transmission and PDCP PDU reordering for reception)
duplicate detection function (e.g., duplicate detection of lower layer SDUs at PDCP re-establishment procedure for RLC AM)
retransmission function (e.g., retransmission of PDCP SDUs at handover and, for split bearers in DC, of PDCP PDUs at PDCP data-recovery procedure, for RLC AM)
ciphering and deciphering function
timer-based SDU discarding function (e.g., timer-based SDU discarding in uplink)

The RLC 2-10 or 2-35 may reconfigure a PDCP PDU into a suitable size to perform e.g., an automatic repeat request (ARQ) operation. The main functions of the RLC may be summarized as follows:
data transfer function (e.g., transfer of upper layer PDUs)
ARQ function (e.g., error correction through ARQ (only for AM data transfer))
concatenation, segmentation, and reassembling function (e.g., concatenation, segmentation and reassembly of RLC SDUs (only for UM and AM data transfer))
re-segmentation function (e.g., re-segmentation of RLC data PDUs (only for AM data transfer))
reordering function (e.g., reordering of RLC data PDUs (only for UM and AM data transfer))
duplicate detection function (e.g., duplicate detection (only for UM and AM data transfer))
error detection function (e.g., protocol error detection (only for AM data transfer))
RLC service data unit (SDU) discard function (e.g., RLC SDU discard (only for unacknowledged mode (UM) and AM data transfer))
RLC re-establishment function

The MAC layer 2-15 or 2-30 may be connected to a number of RLC layer entities configured in one UE, and may perform operations of multiplexing RLC PDUs to a MAC PDU and demultiplexing RLC PDUs from a MAC PDU. The main functions of the MAC layer 1b-15 or 1b-30 may be summarized as follows:
mapping function (e.g., mapping between logical channels and transport channels)
multiplexing and demultiplexing function (e.g., multiplexing/demultiplexing of MAC SDUs belonging to one or different logical channels into/from transport blocks (TB) delivered to/from the physical layer on transport channels)
scheduling information report function
hybrid automatic repeat request (HARQ) function (error correction through HARQ)
logical channel priority control function (e.g., priority handling between logical channels of one UE)
UE priority control function (e.g., priority handling between UEs by means of dynamic scheduling)
multimedia broadcast and multicast service (MBMS) service identification function
transport format selection function
padding function

The PHY layer 2-20 or 2-25 may perform channel coding and modulation on higher layer data, form the data into OFDM symbols and transmit them on a radio channel, or may demodulate OFDM symbols received through a radio channel, perform channel decoding on them and send the result to a higher layer.

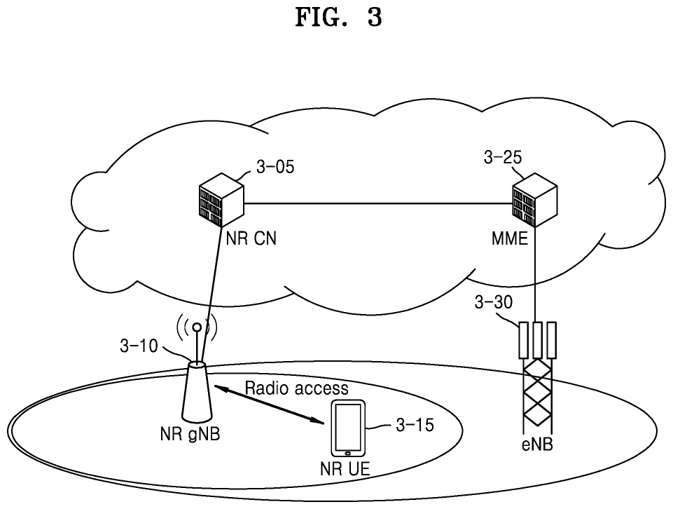

FIG. 3 illustrates a structure of a next generation mobile communication system, according to an embodiment of the disclosure.

Referring to FIG. 3, a radio access network of the next generation mobile communication system (hereinafter, NR or 5G) may include a new radio node B, hereinafter, referred to as an NR gNB or NR BS 3-10, and a new radio core network (NR CN) 3-05. A new radio user equipment (NR UE or terminal) 3-15 may access an external network through the NR gNB 3-10 and the NR CN 3-05.

In FIG. 3, the NR gNB 3-10 may correspond to an evolved Node B (eNB) of the existing LTE system. The NR gNB may be connected to the NR UE 3-15 via a radio channel, and may provide much better service than the existing node B does. In the NR system, all user traffic may be served on shared channels. Accordingly, there is a need for a device for aggregating status information about buffer status of UEs, available transmission power status, channel conditions, etc., together and schedule them, and the NR gNB 3-10 may serve as the device. A single NR gNB may control a number of cells. In the NR system, to achieve ultra high-speed data transmission compared to the current LTE, bandwidth greater than the current maximum bandwidth may be applied. Furthermore, a beamforming technology may be additionally combined with a radio access technology employing OFDM. An adaptive modulation and coding (AMC) scheme that determines a modulation scheme and a channel coding rate according to the channel condition of the UE may also be used. The NR CN 3-05 may perform such functions as supporting mobility, setting up a bearer, setting quality of service (QOS), etc. NR CN is a device responsible for various control functions as well as mobility management functionality for the UE, and may be connected to a number of BSs. Moreover, the NR system may cooperate with the existing LTE system, in which case the NR CN may be connected to an MME 3-25 through a network interface. The MME may be connected to an existing BS, eNB 3-30.

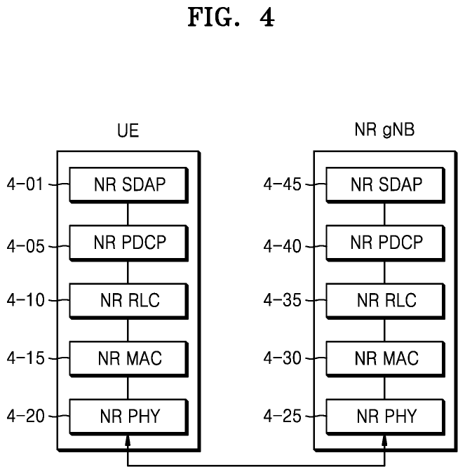

FIG. 4 illustrates a radio protocol architecture of an NR system, according to an embodiment of the disclosure.

Referring to FIG. 4, a radio protocol for the NR system includes, for each of a UE and an NR gNB, an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25.

Main functions of the NR SDAP 4-01 or 4-45 may include some of the following functions:
a function of transfer of user plane data
a function of mapping between a quality of service (QOS) flow and a data bearer (DRB) for both downlink (DL) and uplink (UL)
a function of marking QoS flow identification (ID) in both UL and DL
function of mapping of a reflective QoS flow to a DRB for UL SDAP PDUs.

For an SDAP layer entity, the UE may receive a configuration of whether to use a header of the SDAP layer entity or whether to use a function of the SADP layer entity for each PDCP layer entity, each bearer or each logical channel in a radio resource control (RRC) message received from the BS. When an SDAP header is configured, a 1-bit non-access stratum (NAS) reflective QoS (NAS reflective QoS) indicator and a 1-bit access stratum (AS) reflective QOS (AS reflective QoS) indicator may be used to indicate for the UE to update or reconfigure the mapping information between the UL and DL QOS flow and the data bearer. The SDAP header may include QoS flow ID information indicating QoS. The QoS flow ID information may be used for data process priority, scheduling, etc., for smoother services.

Main functions of the NR PDCP 4-05 or 4-40 may include some of the following functions:
header compression and decompression function (e.g., header compression and decompression: robust header compression (ROHC) only)
user data transfer function
sequential delivery function (e.g., in-sequence delivery of upper layer PDUs)
non-sequential delivery function (e.g., out-of-sequence delivery of upper layer PDUs)
reordering function (e.g., PDCP PDU reordering for reception)
duplicate detection function (e.g., duplicate detection of lower layer SDUs)
retransmission function (e.g., retransmission of PDCP SDUs)
ciphering and deciphering function
timer-based SDU discarding function (e.g., timer-based SDU discarding in uplink)

In the above description, the reordering function of the NR PDCP device may refer to a function of reordering PDCP PDUs received from a lower layer based on PDCP sequence numbers (SNs). The reordering function of the NR PDCP device may include a function of delivering data to a higher layer in the reordered sequence or delivering the data directly to the higher layer without considering the sequence, a function of reordering the sequence to record missing PDCP PDUs, a function of reporting status of missing PDCP PDUs to a transmitting end, or a function of requesting retransmission of missing PDCP PDUs.

Main functions of the NR RLC 4-10 or 4-35 may include some of the following functions:
data transfer function (e.g., transfer of upper layer PDUs)
sequential delivery function (e.g., in-sequence delivery of upper layer PDUs)
non-sequential delivery function (e.g., out-of-sequence delivery of upper layer PDUs)
ARQ function (e.g., error correction through ARQ)
concatenation, segmentation, and reassembling function (e.g., concatenation, segmentation and reassembly of RLC SDUs)
re-segmentation function (e.g., re-segmentation of RLC data PDUs)
reordering function (e.g., reordering of RLC data PDUs)
duplicate detection function
error detection function (e.g., protocol error detection)
RLC SDU discard function
RLC re-establishment function

In the aforementioned description, the sequential delivery function of the NR RLC device may refer to a function of delivering RLC SDUs received from a lower layer to a higher layer in sequence. When several RLC SDUs split from an original RLC SDU are received, the sequential (in-sequence) delivery of the NR RLC device may include a function of re-assembling them and delivering the result.

The sequential delivery function of the NR RLC device may include a function of reordering the received RLC PDUs based on RLC sequence numbers (SNs) or PDCP SNs, a function of reordering the sequence to record missing RLC PDUs, a function of reporting status of missing RLC PDUs to a transmitting end, or a function of requesting retransmission of missing PDCP PDUs.

The sequential delivery function of the NR RLC device may include, when there is a missing RLC SDU, a function of delivering only RLC SDUs before the missing RLC SDU to a higher layer in sequence.

The sequential delivery function of the NR RLC device may include, when a certain timer has been expired even though there is a missing RLC SDU, a function of delivering all the received RLC SDUs to a higher layer in sequence before the timer is started.

The sequential delivery function of the NR RLC device may include, when a certain timer has been expired even though there is a missing RLC SDU, a function of delivering all the RLC SDUs received until the present time to a higher layer in sequence.

The NR RLC device may process the RLC PDUs out of sequence from the sequence numbers but in reception order, and deliver the result to the NR PDCP device.

When receiving segments, the NR RLC device may receive segments stored in the buffer or segments received later and reassemble them into a complete RLC PDU, and deliver the RLC PDU to the NR PDCP device.

The NR RLC layer may not include the concatenation function, and the concatenation function may be performed in the NR MAC layer or replaced with the multiplexing function of the NR MAC layer.

In the aforementioned description, the non-sequential delivery (out-of-sequence delivery) function of the NR RLC device may refer to a function of delivering RLC SDUs received from a lower layer directly to a higher layer without regard to the sequence of the RLC SDUs. The non-sequential delivery function of the NR RLC device may include, when several RLC SDUs split from an original RLC SDU is received, a function of reassembling them and delivering the result. The non-sequential delivery function of the NR RLC device may include a function of storing RLC sequence numbers (SNs) or PDCP SNs of the received RLC PDUs and ordering the sequence to record missing RLC PDUs.

The NR MAC layer 4-15 or 4-30 may be connected to multiple NR RLC layer entities configured in the same UE, and main functions of the NR MAC layer may include some of the following functions:
mapping function (e.g., mapping between logical channels and transport channels) multiplexing and demultiplexing function (e.g.,
   multiplexing/demultiplexing of MAC SDUs)
scheduling information report function
HARQ function (e.g., error correction through HARQ)
logical channel priority control function (e.g., priority handling between logical channels of one UE)
UE priority control function (e.g., priority handling between UEs by means of dynamic scheduling)
MBMS service identification function
transport format selection function
padding function

The NR PHY layer 4-20 or 4-25 may perform channel coding and modulation on higher layer data, form the data into OFDM symbols and send them on a radio channel, or may demodulate OFDM symbols received on a radio channel, perform channel decoding on them and send the result to a higher layer.

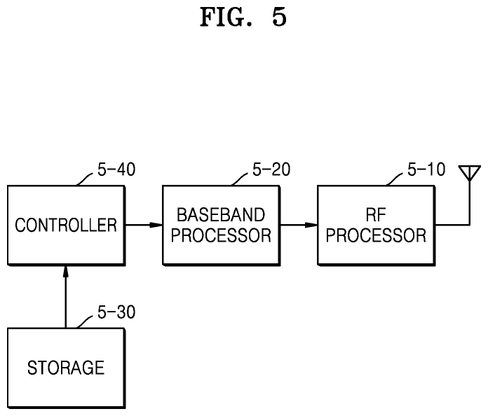

FIG. 5 is a block diagram illustrating an internal structure of a UE, according to an embodiment of the disclosure.

Referring to the block diagram, the UE includes a radio frequency (RF) processor 5-10, a baseband processor 5-20, a storage 5-30, and a controller 5-40.

The RF processor 5-10 performs functions, such as band conversion, amplification, etc., of a signal to transmit or receive the signal on a radio channel. Specifically, the RF processor 5-10 up-converts a baseband signal provided from the baseband processor 5-20 to an RF band signal for transmission through an antenna, and down-converts an RF band signal received through the antenna to a baseband signal. For example, the RF processor 5-10 may include a transmit filter, a receive filter, an amplifier, a mixer, an oscillator, a digital to analog converter (DAC), an analog to digital converter (ADC), etc. Although only one antenna is shown in FIG. 5, the UE may be equipped with multiple antennas. The RF processor 5-10 may also include multiple RF chains. Furthermore, the RF processor 5-10 may perform beamforming. For beamforming, the RF processor 5-10 may control the phase and amplitude of each signal to be transmitted or received through multiple antennas or antenna elements. Furthermore, the RF processor 5-10 may perform multiple-input-multiple-output (MIMO), and may receive a number of layers during the MIMO operation.

The baseband processor 5-20 performs conversion between a baseband signal and a bit sequence based on a physical layer standard of the system. For example, for data transmission, the baseband processor 5-20 generates complex symbols by encoding and modulating a bit sequence for transmission. Furthermore, when data is received, the baseband processor 5-20 reconstructs a received bit sequence by demodulating and decoding the baseband signal provided from the RF processor 5-10. For example, in a case of conforming to an OFDM scheme, for data transmission, the baseband processor 5-20 generates complex symbols by encoding and modulating a bit sequence for transmission, maps the complex symbols to subcarriers, and performs inverse fast Fourier transform (IFFT) operation and cyclic prefix (CP) insertion to construct OFDM symbols. Furthermore, for data reception, the baseband processor 5-20 divides a baseband signal provided from the RF processor 5-10 into OFDM symbol units, reconstructs the signals mapped to the subcarriers through fast Fourier transform (FFT) and then reconstructs a received bit sequence through demodulation and decoding.

The baseband processor 5-20 and the RF processor 5-10 transmit and receive signals as described above. The baseband processor 5-20 and the RF processor 5-10 may be referred to as a transmitter, a receiver, a transceiver, or a communicator. Furthermore, at least one of the baseband processor 5-20 and the RF processor 5-10 may include multiple communication modules to support many different radio access technologies. Moreover, at least one of the baseband processor 5-20 and the RF processor 5-10 may include different communication modules to process different frequency band signals. For example, the different radio access technologies may include a WLAN, e.g., the IEEE 802.11, a cellular network, e.g., LTE, etc. Furthermore, the different frequency bands may include a super high frequency (SHF) (e.g., 2.NRHz, NRhz) band, and millimeter wave (mmwave) (e.g., 60 GHz) band.

The storage 5-30 stores a basic program for operation of the UE, an application program, data such as configuration information. In particular, the storage 5-30 may store information regarding a second access node that performs wireless communication using a second radio access technology. The storage 5-30 provides data stored therein at the request of the controller 5-40.

The controller 5-40 controls general operations of the UE. For example, the controller 5-40 transmits or receives signals through the baseband processor 5-20 and the RF processor 5-10. The controller 5-40 also records or reads data onto or from the storage 5-40. For this, the controller 5-40 may include at least one processor. For example, the controller 5-40 may include a communication processor (CP) for controlling communication and an application processor (AP) for controlling a higher layer such as an application program.

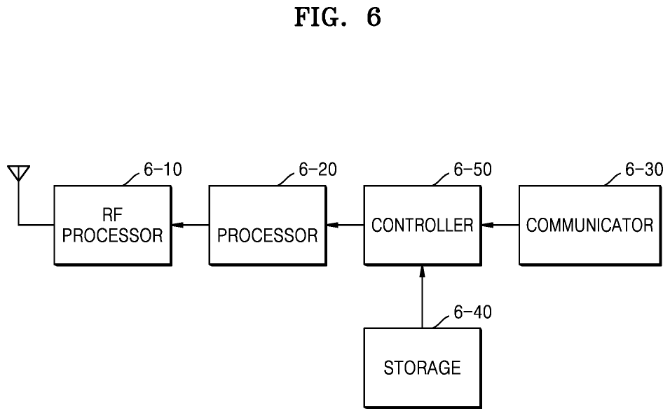

FIG. 6 is a block diagram illustrating a configuration of a BS, according to an embodiment of the disclosure.

As shown in FIG. 6, the BS (or gNB) includes an RF processor 6-10, a baseband processor 6-20, a communicator 6-30, a storage 6-40, and a controller 6-50.

The RF processor 6-10 performs functions, such as band conversion, amplification, etc., of a signal to transmit or receive the signal on a radio channel. Specifically, the RF processor 6-10 up-converts a baseband signal provided from the baseband processor 6-20 to an RF band signal for transmission through an antenna, and down-converts an RF band signal received through the antenna to a baseband signal. For example, the RF processor 6-10 may include a transmit filter, a receive filter, an amplifier, a mixer, an oscillator, a DAC, an ADC, etc. Although a single antenna is shown in FIG. 6, a first access node may include multiple antennas. The RF processor 6-10 may also include many RF chains. Furthermore, the RF processor 6-10 may perform beamforming. For beamforming, the RF processor 6-10 may control the phase and amplitude of each signal to be transmitted or received through multiple antennas or antenna elements. The RF processor may perform downlink MIMO operation by transmitting one or more layers.

The baseband processor 6-20 performs conversion between a baseband signal and a bit sequence based on a physical layer standard of a first radio access technology. For example, for data transmission, the baseband processor 6-20 generates complex symbols by encoding and modulating a bit sequence for transmission. Furthermore, when data is received, the baseband processor 6-20 reconstructs a received bit sequence by demodulating and decoding the baseband signal provided from the RF processor 6-10. For example, when conforming to an OFDM scheme, for data transmission, the baseband processor 6-20 may generate complex symbols by encoding and modulating a bit sequence for transmission, map the complex symbols to subcarriers, and then reconstruct OFDM symbols by IFFT operation and CP insertion. Moreover, for data reception, the baseband processor 6-20 divides a baseband signal provided from the RF processor 6-10 into OFDM symbol units, reconstructs the signals mapped to the subcarriers through FFT operation and then reconstructs a received bit sequence through demodulation and decoding. The baseband processor 6-20 and the RF processor 6-10 transmit and receive signals as described above. The baseband processor 6-20 and the RF processor 6-10 may be referred to as a transmitter, a receiver, a transceiver, or a wireless communicator.

The backhaul communicator 6-30 provides an interface for communicating with other nodes in the network. Specifically, the backhaul communicator 6-30 converts a bit sequence to be transmitted from this primary BS to another node, e.g., a secondary BS, a core network, etc., into a physical signal, and converts a physical signal received from another node to a bit sequence.

The storage 6-40 stores a basic program for operation of the primary BS, an application program, data such as configuration information. Especially, the storage 6-40 may store information about a bearer allocated to a connected UE, measurements reported from the UE, etc. Furthermore, the storage 6-40 may store information used as a criterion for determining whether to provide or stop multi-connection for the UE. The storage 6-40 provides data stored therein at the request of the controller 6-50.

The controller 6-50 controls general operations of the primary BS. For example, the controller 6-50 transmits or receives signals through the baseband processor 6-20 and the RF processor 6-10 or the backhaul communicator 6-30. The controller 6-50 also records or reads data onto or from the storage 6-40. For this, the controller 6-50 may include at least one processor.

Assuming that a positioning integrity (PI) result calculating entity and a PI decision entity are different entities, the PI decision entity provides key performance indicator (KPI) information to the PI result calculating entity, and the PI result calculating entity may in turn, calculate a PI result by taking into account the provided KPI information, received assistance information and assisted global navigation satellite system (A-GNSS) measurement information and report a result of the calculating to the PI decision entity.

In this case, one of the result values, a protection level (PL) value may be determined in real time based on past values of the measured sample result values and given KPI values. The value determined in this manner needs to be sent to the PI decision entity and reflected in PI decision in real time.

Always transmitting the result values determined in real time to the PI decision entity causes signal overhead. The frequent transmission of the result values may not matter in some situations, but for a certain case, the number of transmission times needs to be reduced and only a value for an absolutely essential case needs to be selected and transmitted.

How to transfer a PI result may have options as will be described below, and an indicator indicating the method corresponding to each option and information required to report the PI result may be sent in a PI assistance message along with a KPI from the PI decision entity to the PI result calculating entity.

Various embodiments of the disclosure related to a method of transferring the PL value from the PI result calculating entity to the PI decision entity will now be described.

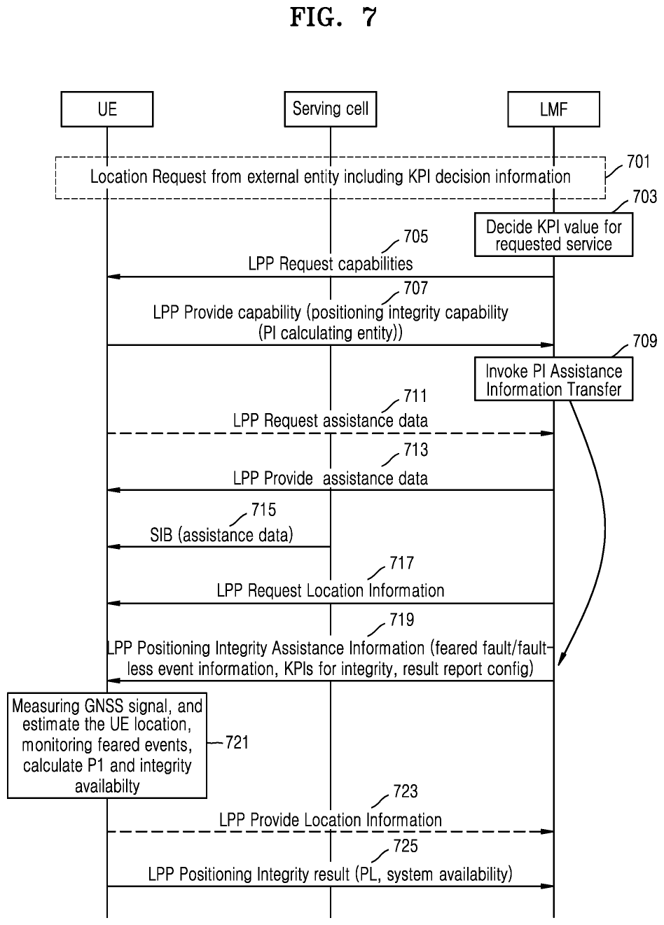

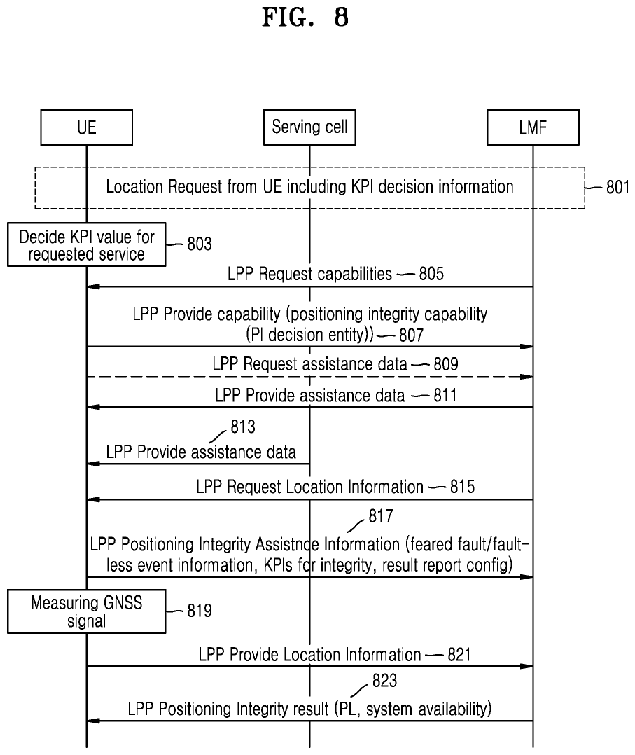

The term calculating from the expression ‘PI result calculating entity’ may refer to computing. Furthermore, the PI decision entity may be a location service (LCS) entity. In FIG. 7, shown is an occasion when a UE is the PI result calculating entity and an LMF is the PI decision entity or an LCS entity. Furthermore, in FIG. 8, shown is an occasion when a UE includes an LCS entity or a PI decision entity, and an LMF is a PI result calculating entity.

An indicator about what type of method will be used among methods of transferring a PI result to the PI decision entity and additional information required for each method (periodicity for being periodic, a relative value, an absolute value, or an interval value for being event-triggered) may be determined by the PI decision entity. The PI decision entity may send the indicator and the additional information in an LTE positioning protocol (LPP) PI assistance information message to the PI calculating entity. On receiving this, the PI calculating entity may then derive a PI result and send the result value to the PI decision entity.

In an embodiment of the disclosure, the PI result calculating entity may transmit information about a PL value to the PI decision entity in a one-shot mode. After receiving an LPP message including a KPI value for a KPI provided in the PI assistance message, the PI result calculating entity may perform GNSS signal measurement and correction of an associated error value, determine a PL value (and corresponding system availability), add the result to a PI result transfer message (e.g., an LPP PI result message transmitted by the UE to the LMF in operation 725 of FIG. 7 and an LPP PI result message transmitted by the LMF to the UE in operation 823 of FIG. 8, as will be described later) or an LPP message including information about the PI result and transfer the message. The KPI value refers to information representing a target integrity risk (TIR), information indicating an alert limit (AL), or information indicating time-to-alert (TTA), and may be determined and delivered by the PI decision entity. A definition of the same KPI will now be used. For example, the PI result calculating entity may transmit the information about the PL value to the PI decision entity one time in the one-shot mode.

In another embodiment of the disclosure, the PI result calculating entity may transmit information about a PL value to the PI decision entity in a periodic report mode. When a PL and corresponding system availability are determined and possible to be transmitted during a given time (e.g., which refers to the TTA value in the KPI) or predefined time for the KPI given in the PI assistance message, the PI result calculating entity may report the PL and the system availability to the PI decision entity and periodically report available result values to the PI decision entity at the time at regular intervals. (For example, an LPP PI result message transmitted by the UE to the LMF in operation 725 of FIG. 7 and an LPP PI result message transmitted by the LMF to the UE in operation 823 of FIG. 8, as will be described later). The result value is a recalculated value as compared to the previous value based on a report point in time. In this case, a periodic report indicator and a value of report interval of the result message may be added to the message including the given KPI information.

An indicator or information to stop transferring the periodic report may be transmitted later in the same type of message that has transmitted the associated KPI information, and on receiving this information, the PI result calculating entity may stop periodic reporting. For example, the PI result calculating entity may be included in the UE or the LMF.

In another embodiment of the disclosure, the PI result calculating entity may transmit information about a PL value to the PI decision entity in the event-triggered mode. When a PL and corresponding system availability are determined during a given or predefined time for the KPI given in the PI assistance message, a condition to report the result value may be designated. Accordingly, the PI result calculating entity may transmit the PI result message to the PI decision entity when the following conditions are satisfied.

For a range of the PL value to be reported, when the following condition is determined and satisfied for a PL value determined at each instant, the PI result calculating entity may report the PI result value to the PI decision entity.

Absolute value: reported when a calculated PL value is the absolute value or more or less

Relative value or offset: reported when a current result value increases or decreases by a given offset value as compared to a PL value first calculated and reported at a time when the condition is received during a preset time interval

Specific interval value: having a maximum value and a minimum value and reported when there is a PL calculated in a range between the values. Alternatively, it may be reported when exceeding the range.

The absolute value, the relative value and time interval values required for them, and the specific interval values may be determined and sent by the PI decision entity in an assistance message.

Various embodiments of the disclosure related to a method of transferring a system availability metric from the PI result calculating entity to the PI decision entity will now be described.

In an embodiment of the disclosure, the PI result calculating entity may transmit information about the system availability to the PI decision entity in the one-shot mode. For example, the PI result calculating entity may represent a system availability newly calculated based on a KPI value given in the PI assistance message with a 1-bit indicator. The indicator may indicate one of the following: {available, unavailable}

In another embodiment of the disclosure, the PI result calculating entity may transmit information about the system availability to the PI decision entity in the periodic report mode. The PI result calculating entity may periodically report an availability result newly calculated for each time interval based on the KPI value given in the PI assistance message to the PI decision entity in the 1-bit indicator. In this case, a periodic report indicator and a value of reporting interval of the PI result message may be added to the message including the given KPI.

An indicator or information to stop transferring the periodic report may be transmitted later in the same type of message that has transmitted the associated KPI information, and on receiving this information, the PI result calculating entity may stop the periodic reporting.

In another embodiment of the disclosure, the PI result calculating entity may transmit information about system availability to the PI decision entity in the event-triggered mode. The PI result calculating entity may represent the system availability newly calculated based on a KPI value given in the PI assistance message with a 1-bit indicator. After this, the PI result calculating entity may report the information about the system availability to the PI decision entity only when the result value constantly obtained by the PI result calculating entity is changed as compared to the first reported.

Messages that may include the aforementioned information will now be described.

The PI result may be transmitted in an LPP provide location information message. In this case, positioning measurement information and an integrity calculation result may be simultaneously transmitted in the message.

Content of the PI assistance information may be transmitted in an LPP ProvideAssistanceData message. In this case, the positioning measurement operation and the PI calculating operation may be started at the same time. When the PI assistance message and the request location information message are separated and deliver their respective contents, a positioning signal measurement operation and a related integrity calculating operation may be started at the receiving end of the message from the time at which each message is received.

Information about possible options of the PI result transfer method may be notified to the PI result calculating entity by adding information about the aforementioned transfer option about the PI result transfer method to the PI assistance information. (A parameter required needs to be included for each option)

In addition, PI related capability of the UE, i.e., a capability bit related to whether it is a PI calculating entity or a decision entity, may be added to the provide capability message. Each bit may refer to whether the bit has a calculating function or not, or whether the bit has a decision entity function or not.

FIG. 7 is a flowchart of an occasion when the PI calculating entity is a UE and the PI decision entity is an LMF in a case of UE based positioning or mobile terminated location requests (MT-LR).

In operation 701, a location service request may be initiated by an external entity because it is a case of MT-LR. Not only in the case that the location service request is performed by the external entity but also in a case that the location service request is performed by another entity or the UE, the LMF may start a positioning operation, i.e., start LPP signaling. In this case, an entity that requests a location service may deliver information for determining a PI related KPI in the service to the LMF.

In operation 703, based on the information for determining the PI related KPI, the LMF may determine KPI values related to the requested service for the UE.

After this, in operation 705, the LMF may request capability from the UE. For example, the LMF may transmit an LPP request capability message to the UE.

In operation 707, the UE may report an indicator or field about whether the UE has a capability of the PI calculating entity or a capability of the PI decision entity as a PI capability in addition to an existing positioning related capability. For example, the UE may transmit an LPP provide capability message to the LMF. The LPP provide capability message may include a PI related capability of the UE, i.e., a capability bit related to whether the UE is the PI calculating entity or the PI decision entity. Each bit may be a bit that refers to whether the UE has a PI calculating function or not, or refers to whether the UE has the PI decision entity function or not.

When the indicator included in the PI related UE capability message transmitted in operation 707 indicates the PI calculating capability, the LMF may invoke PI assistance information transfer in operation 709.

Based on this, in operation 719, the LMF may deliver information for PI related calculation to the UE in an LPP PI assistance information message.

Apart from this, the LMF may deliver GNSS related LPP assistance information in a unicast message to the UE in operation 713, or deliver GNSS related assistance information to the UE through broadcast from a serving cell in operation 715. For example, the UE may transmit the LPP request assistance data to the LMF in operation 711, and in response to this, the LMF may transmit the LPP provide assistance data to the UE in operation 713.

In operation 717, the LMF may request measurement of location information from the UE, e.g., the LMF may transmit LPP request location information to the UE.

With this, the UE may measure a GNSS signal in operation 721.

Furthermore, in operation 719, the LMF may deliver various feared event information that may be an error source of the GNSS to the UE in an LPP PI assistance information message, and deliver integrity result report configuration information and KPI determined by the LMF to the UE.

In an embodiment of the disclosure, the PI result transfer method may have various options as described above, and the LMF may transmit information required to report an indicator (result report config) indicating a method corresponding to each option and a PI result to the UE in the PI assistance message. In operation 721, the UE may, based on a GNSS signal result measured based on the received information, estimate a UE location and monitor a feared event to calculate a PL value taking into account an error source of the measurement result.

In operation 723, the UE may transmit location information to the LMF. For example, the UE may transmit, to the LMF, a result value of the GNSS signal measurement based on the LPP provide location information.

In operation 725, the UE may transmit information about a PI result to the LMF based on the indicator (result report config) indicating an option of the PI result transfer method. In a case that this value is calculated, how to report the result is changed depending on the option indicated by the result report config.

In a case that the LMF sets up a one-shot mode for the PL transfer method, the UE transmits, to the LMF, the calculated PL and a system availability value based on the PL one time.

In a case that the LMF sets up a periodic reporting mode for the PL transfer method, the UE may recalculate a PL value in every set period and report the PL value to the LMF along with the associated system availability value.

In a case that the LMF sets up an event triggered reporting mode for the PL transfer method, the UE may report the calculated PL value to the LMF along with the associated system availability value when the PL value corresponds to the set absolute/offset/interval values.

Similarly, in a case that the LMF sets up the one-shot mode for the system availability transfer method, the UE transmits, to the LMF, the calculated system availability value one time.

In a case that the LMF sets up a periodic reporting mode for the system availability transfer method, the UE may recalculate a PL value in every set period and report the associated system availability value to the LMF.

In a case that the LMF sets up event triggered reporting for the system availability transfer method, when a different value than the system availability value is calculated after the first one-time reporting, the system availability value may be reported to the LMF.

FIG. 8 is a flowchart of an occasion when a PI calculating entity is an LMF and a PI decision entity is a UE in a UE assisted case, i.e., in a case of LMF based positioning and mobile originated location requests (MO-LR).

In operation 801, a location service request may be started by the UE. Not only in the case that the location service request is performed by the UE but also in a case that the location service request is performed by another entity, the LMF may start a positioning operation, i.e., LPP signaling.

In operation 803, a KPI related to PI for the service may be determined by an entity such as an application residing in the UE.

After this, in operation 805, the LMF may send a request to the UE for its capability. For example, the LMF may transmit an LPP request capability message to the UE.

In operation 807, the UE may report an indicator or field about whether the UE has a capability of the PI calculating entity or a capability of the PI decision entity as a PI capability in addition to an existing positioning related capability. For example, the UE may transmit an LPP provide capability message to the LMF. The LPP provide capability message may include a PI related capability of the UE, i.e., a capability bit related to whether the UE is the PI calculating entity or the PI decision entity. Each bit may be a bit that refers to whether the UE has a PI calculating function or not, or refers to whether the UE has the PI decision entity function or not.

When the indicator included in a PI related UE capability message transmitted in operation 807 corresponds to the capability of the PI decision entity, based on this, the LMF may transmit PI related calculation results to the UE.

Apart from this, the LMF may deliver GNSS related LPP assistance information to the UE in a unicast message in operation 811, or deliver GNSS related assistance information to the UE through broadcast from a serving cell in operation 813. For example, the UE may transmit the LPP request assistance data to the LMF in operation 809, and in response to this, the LMF may transmit the LPP provide assistance data to the UE in operation 811.

In operation 815, the LMF may request measurement of location information from the UE, e.g., the LMF may transmit LPP request location information to the UE.

With this, the UE may measure a GNSS signal in operation 819.

In operation 817, the UE may deliver, to the LMF, various feared event information that may be an error source of the GNSS and deliver integrity result report configuration information and a KPI determined by the UE in an LPP PI assistance information message.

In an embodiment of the disclosure, there may be various options for the PI result transfer method as described above, and the UE or an LCS entity (PI decision entity) residing in the UE may determine the various options for the PI result transfer method. The UE may transmit, to the LMF, an indicator (result report config) referring to a method corresponding to each option and information required to report the PI result in a PI assistance message.

In operation 821, the UE may report, to the LMF, a GNSS signal result measured based on the assistance information received in operations 811 and 813 in an LPP provide location information message.

The LMF may estimate a UE location based on the GNSS signal measurement, and monitor a feared event to calculate a PL value taking into account an error source of the measurement.

In operation 823, the LMF may transmit information about a PI result to the UE based on the indicator (result report config) indicating an option of the PI result transfer method.

In a case that a PL value is calculated, the result reporting mode is changed depending on an option indicated by the indicator (result report config) that indicates the option of the PI result transfer method.

In a case that the UE sets up a one-shot mode for the PL transfer method, the LMF transmits, to the UE, the calculated PL and a system availability value based on the PL one time.

In a case that the UE sets up a periodic reporting mode for the PL transfer method, the LMF may recalculate a PL value in every set period and report the PL value to the UE along with the associated system availability value.

In a case that the UE sets up event triggered reporting for the PL transfer method, the LMF may report the calculated PL value to the UE along with the associated system availability value when the PL value corresponds to the set absolute/offset/interval values.

Similarly, in a case that the UE sets up the one-shot mode for the system availability transfer method, the LMF transmits, to the UE, the calculated system availability value one time.

In a case that the UE sets up a periodic reporting mode for the system availability transfer method, the LMF may recalculate a PL value in every set period and report the associated system availability value to the UE.

In a case that the UE sets up event triggered reporting for the system availability transfer method, when a different value than the system availability value is calculated after the first one-time reporting, the system availability value may be reported to the UE.

According to an embodiment of the disclosure, a method performed by a UE in a wireless communication system may be provided. The method may include transmitting, to a location server, capability information of the UE related to GNSS PI; receiving information about one or more KPIs from the location server; and transmitting, to the location server, resultant information about the GNSS PI based on the one or more KPIs.

In an embodiment, the capability information may be transmitted to the location server in an LPP message indicating an LPP capability of the UE.

In an embodiment, the information about one or more KPIs may include information about a target integrity risk (TIR).

In an embodiment, the information about KPIs may be received from the location server in an LPP message.

In an embodiment, the resultant information may include information about a PL.

In an embodiment, the resultant information may be transmitted to the location server in an LPP message providing positioning measurement information or positioning estimation information.

In an embodiment, the location server may include a location management function (LMF) entity.

According to an embodiment of the disclosure, a UE may be provided in a wireless communication system. The UE may include a transceiver; and at least one processor for transmitting, to a location server through the transceiver, capability information of the UE related to GNSS PI, receiving information about one or more KPIs from the location server through the transceiver, and transmitting, to the location server through the transceiver, resultant information about the GNSS PI based on the one or more KPIs.

In an embodiment, the capability information may be transmitted to the location server in an LPP message indicating an LPP capability of the UE.

In an embodiment, the information about one or more KPIs may include information about a TIR.

In an embodiment, the information about KPIs may be received from the location server in an LPP message.

In an embodiment, the resultant information may include information about a PL.

In an embodiment, the resultant information may be transmitted to the location server in an LPP message providing positioning measurement information or positioning estimation information.

In an embodiment, the location server may include an LMF entity.

According to an embodiment of the disclosure, a method performed by a location server in a wireless communication system may be provided. The method may include receiving, from a UE, capability information of the UE related to GNSS PI; transmitting information about one or more KPIs to the UE; and receiving, from the UE, resultant information about the GNSS PI based on the one or more KPIs.

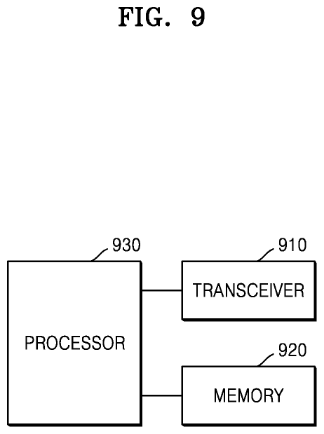

FIG. 9 is a block diagram of a UE, according to an embodiment of the disclosure.

Referring to FIG. 9, the UE in the disclosure may include a transceiver 910, a memory 920, and a processor 930. The transceiver 910, the memory 920, and the processor 930 of the UE may operate according to the aforementioned communication method of the UE. Components of the UE are not, however, limited thereto. For example, the UE may include more or fewer elements than described above. In addition, the transceiver 910, the memory 920, and the processor 930 may be implemented in a single chip.

The transceiver 910 is a collective term of a UE transmitter and a UE receiver, and may transmit or receive a signal to or from a network entity. The signal to be transmitted to or received from the BS may include control information and data. For this, the transceiver 910 may include an RF transmitter for up-converting the frequency of a signal to be transmitted and amplifying the signal and an RF receiver for low-noise amplifying a received signal and down-converting the frequency of the received signal. It is merely an embodiment of the transceiver 910, and the elements of the transceiver 910 are not limited to the RF transmitter and RF receiver.

The transceiver 910 may include a wired/wireless transceiver, including various components for signal transmission and reception.

In addition, the transceiver 910 may receive a signal on a wired or wireless channel and output the signal to the processor 930, or transmit a signal output from the processor 930 on a wired or wireless channel.

The transceiver 910 may receive a communication signal and output the communication signal to the processor 730, and transmit a signal output from the processor 730 to a network entity over a wired or wireless network.

The memory 920 may store a program and data required for operation of the UE. Furthermore, the memory 920 may store control information or data included in a signal obtained by the UE. The memory 920 may include a storage medium such as a read only memory (ROM), a random access memory (RAM), a hard disk, a compact disc ROM (CD-ROM), and a digital versatile disk (DVD), or a combination of storage mediums.

The processor 930 may control a series of processes for the UE to be operated according to the embodiments of the disclosure. The processor 930 may include at least one processor. For example, the processor 930 may include a communication processor (CP) for controlling communication and an application processor (AP) for controlling a higher layer such as an application program.

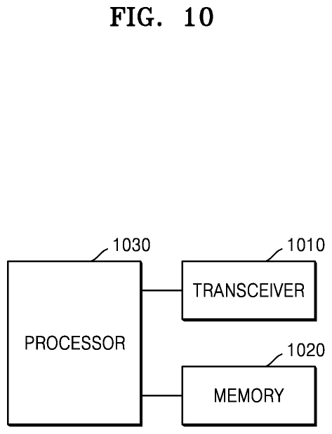

FIG. 10 is a block diagram of a BS, according to an embodiment of the disclosure.

Referring to FIG. 10, the BS in the disclosure may include a transceiver 1010, a memory 1020, and a processor 1030. The transceiver 1010, the memory 1020, and the processor 1030 of the BS may operate according to the aforementioned communication method of the BS. Components of the BS are not, however, limited thereto. For example, the BS may include more or fewer elements than described above. In addition, the transceiver 1010, the memory 1020, and the processor 1030 may be implemented in a single chip.

The transceiver 1010 is a collective term of a BS receiver and a BS transmitter, and may transmit or receive a signal to or from a UE or another BS. The signal to be transmitted to or received may include control information and data. For this, the transceiver 1010 may include an RF transmitter for up-converting the frequency of a signal to be transmitted and amplifying the signal and an RF receiver for low-noise amplifying a received signal and down-converting the frequency of the received signal. It is merely an example of the transceiver 1010, and the elements of the transceiver 1010 are not limited to the RF transmitter and RF receiver. The transceiver 1010 may include a wired/wireless transceiver, including various components for signal transmission and reception.

In addition, the transceiver 1010 may receive a signal on a communication channel (e.g., a wireless channel) and output the signal to the processor 1030, or transmit a signal output from the processor 1030 on the communication channel.

The transceiver 1010 may receive a communication signal and output the communication signal to the processor 830, and transmit a signal output from the processor 830 to a UE or a network entity over a wired or wireless network.

The memory 1020 may store a program and data required for an operation of the BS. Furthermore, the memory 1020 may store control information or data included in a signal obtained by the BS. The memory 1020 may include a storage medium such as a read only memory (ROM), a random access memory (RAM), a hard disk, a compact disc ROM (CD-ROM), and a digital versatile disk (DVD), or a combination of storage mediums.

The processor 1030 may control a series of processes for the BS to be operated according to the embodiments of the disclosure. The processor 1030 may include at least one processor. Methods according to the claims of the disclosure or the embodiments of the disclosure described in the specification may be implemented in hardware, software, or a combination of hardware and software.

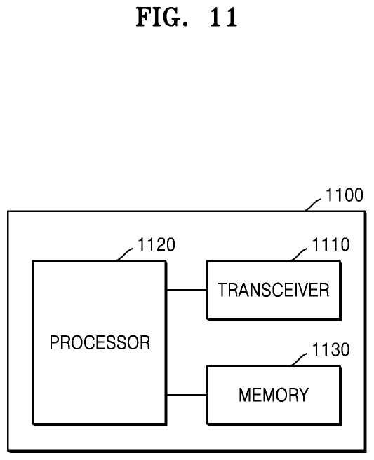

FIG. 11 is a control block diagram of a location server 1100, according to an embodiment.

Referring to FIG. 11, the location server 1100 may include a transceiver 1110, a processor 1120, and a memory 1130. The location server 1100 may be the LMF as described above in connection with FIGS. 1 to 8. The processor 1110, the transceiver 1120, and the memory 1130 may operate according to the aforementioned communication method of the LMF. Elements of the location server 1100 are not, however, limited thereto. For example, the location server 1100 may include more elements (e.g., a network interface controller (NIC)) or fewer elements than described above. In addition, the transceiver 1110, the processor 1130, and the memory 1120 may be implemented in a single chip.

The transceiver 1110 may transmit or receive signals to or from another network entity or the UE. The signal may include at least one message as described above in connection with FIGS. 1 to 8. For this, the transceiver 2600 and 2610 may include an RF transmitter for up-converting the frequency of a signal to be transmitted and amplifying the signal and an RF receiver for low-noise amplifying a received signal and down-converting the frequency of the received signal. It is, however, merely an example of the transceiver 2600 and 2610, and the elements of the transceiver 2600 and 2610 are not limited to the RF transmitter and RF receiver.

In addition, the transceiver may receive a signal on a wireless channel and output the signal to the processor 1120, or transmit a signal output from the processor 1120 on a wireless channel.

The processor 1120 may be hardware to drive software for processing data to be transmitted or received data, and for example, one or more central processing units (CPUs) may be included in the processor 1120. The processor 1120 may drive the software stored in the memory 1130. The processor 1120 may control a series of processes for the location server to be operated according to the embodiments of the disclosure. The processor 1120 may include at least one processor.

The memory 1130 may store software and data required for operation of the location server 1100. Furthermore, the memory 1130 may store control information or data included in a signal obtained by the UE. The memory 1130 may include a storage medium such as a ROM, a RAM, a hard disk, a CD-ROM, and a DVD, or a combination of storage mediums.

Methods according to the claims of the disclosure or the embodiments of the disclosure described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules or software) may be stored in a RAM, a non-volatile memory including a flash memory, a ROM, an electrically erasable programmable ROM (EEPROM), a magnetic disc storage device, a CD-ROM, a DVD or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

Several embodiments of the disclosure have thus been described, but it will be understood that various modifications can be made without departing the scope of the disclosure. Thus, it will be apparent to those ordinary skilled in the art that the disclosure is not limited to the embodiments described, but can encompass not only the appended claims but the equivalents. Thus, it will be apparent to those ordinary skilled in the art that the disclosure is not limited to the embodiments of the disclosure described, which have been provided only for illustrative purposes. Furthermore, the embodiments may be operated by being combined with one another if necessary. For example, parts of the methods proposed in the disclosure may be combined to operate the BS and the UE. Although the embodiments of the disclosure are proposed based on 5G or NR systems, modifications to the embodiments of the disclosure, which do not deviate from the scope of the disclosure, may be applicable to other systems such as an LTE system, an LTE-A system, an LTE-A-Pro system, etc.

1. A method performed by a user equipment (UE) in a wireless communication system, the method comprising:
receiving, from a location server, information associated with a target integrity risk (TIR);
determining integrity information, based on the TIR; and
transmitting, to the location server, the integrity information.

2. The method of claim 1, wherein the integrity information includes information related to at least one protection level (PL).

3. The method of claim 2, wherein the PL is associated with the TIR.

4. The method of claim 1, further comprising:
transmitting, to the location server, information associated with an integrity related capability supported by the UE.

5. The method of claim 4, wherein the information associated with the integrity related capability is transmitted via a message indicating capabilities of the UE.

6. (canceled)

7. The method of claim 1, wherein the location server includes a location management function (LMF).

8. A user equipment (UE) in a wireless communication system, the UE comprising:
a transceiver; and
at least one processor coupled with the transceiver and configured to:
receive, from a location server via the transceiver, information associated with a target integrity risk (TIR),
determine integrity information, based on the TIR, and
transmit, to the location server via the transceiver, the integrity information.

9. The UE of claim 8, wherein the integrity information includes information related to at least one protection level (PL).

10. The UE of claim 9, wherein the PL is associated with the TIR.

11. The UE of claim 8, wherein the at least one processor is further configured to:
transmit, to the location server via the transceiver, information associated with an integrity related capability supported by the UE.

12. The UE of claim 11, wherein the information associated with the integrity related capability is transmitted via a message indicating capabilities of the UE.

13. (canceled)

14. The UE of claim 8, wherein the location server includes a location management function (LMF).

15. A method performed by a location server in a wireless communication system, the method comprising:
transmitting, to a user equipment (UE), information associated with a target integrity risk (TIR); and
receiving, from the UE, integrity information,
wherein the integrity information is determined based on the TIR.

16. The method of claim 15, further comprising:
receiving, from the UE, information associated with an integrity related capability supported by the UE.

17. The method of claim 15, wherein the location server includes a location management function (LMF).
